(19) United States
(12) Patent Application Publication
(10) Pub. No.: US 2026/0152267 A1
(43) Pub. Date: Jun. 4, 2026

(54) TENSION CONTROL METHOD FOR TETHER

(71) Applicant: TOYOTA JIDOSHA KABUSHIKI KAISHA, Toyota-shi (JP)

(72) Inventor: Akihiro HONDA, Gotenba-shi (JP)

(73) Assignee: TOYOTA JIDOSHA KABUSHIKI KAISHA, Toyota-shi (JP)

(21) Appl. No.: 19/367,356

(22) Filed: Oct. 23, 2025

(30) Foreign Application Priority Data
Dec. 2, 2024 (JP) 2024-209416

(51) Int. Cl. B63B 79/10; B63B 79/40; B66D 1/50

(52) U.S. Cl. CPC B63B 79/10; B63B 79/40; B66D 1/505; B63B 2213/02

(57) ABSTRACT

Restores tether tension while suppressing tether winding. A method of controlling the tension of a tether of a flying body moored to a vessel by a tether, wherein the vessel is moved in a direction in which the tether tension recovers when the tether tension detected by a sensor that detects the tension of the tether is less than a threshold value.

### BACKGROUND

### 1. Field

The present disclosure relates to a method of tension control of a tether.

### 2. Description of the Related Art

For tension adjustment of the tether which is a wire-like member for mooring a flying kite or balloon, such as deployable wings, connected to a structure on the ground or the sea, the winding of the tether in Patent Document 1, friction drive roller type winch for controlling the tension in feeding is disclosed.

### CITATION LIST

### Patent Literature

[Patent Literature 1] JP 2024-006736 A

### SUMMARY

### Technical Problem

When a winch system for controlling the tension of the tether is mounted on a ship, the tension of the tether may decrease with the movement of the ship, causing the tether to become entangled. In contrast, it is conceivable to maintain the tension by winding of the tether, but there is a fear that the flight stability of the kite is impaired because the altitude of the kite is lowered due to the winding of the tether.

Accordingly, it is an object of the present disclosure to restore tension of a tether while suppressing winding of a tether.

### Solution to Problem

The present application discloses a method of controlling the tension of a tether of a flying body moored to a vessel by a tether, wherein the tether tension moves the vessel in a direction in which the tether tension recovers when the tether tension detected by a sensor that detects the tension of the tether is less than a threshold value.

The present application discloses a method of controlling the tension of a tether of a flying body moored to a vessel by a tether, wherein the tether tension moves the vessel in a direction in which the tether tension recovers when the difference obtained by subtracting the distance between the vessel and the flying body from the tether drawer length detected by a sensor that detects the drawer length of the tether exceeds a threshold value.

The direction of movement may be determined by the azimuth angle between the vessel and the flying body from the positional information of the flying body and the positional information of the vessel.

The position information of the flying object and the position information of the ship may be obtained by GPS

### Advantageous Effects

According to the present disclosure, it is possible to recover the tether tension while suppressing the winding of the tether, and it is possible to suppress the decrease in the flight stability of the flying object such as kite.

### BRIEF DESCRIPTION OF THE DRAWINGS

FIG. 1 is a diagram illustrating various devices for S10 of how to control tension of tethers.

FIG. 2 is a diagram showing a portion of FIG.

FIG. 3 is a diagram illustrating a controller 50.

FIG. 4 is a diagram representing the flow of the tension control methodology S10 of the tether.

FIG. 5 is a diagram representing the flow of the tension control methodology S20 of the tether.

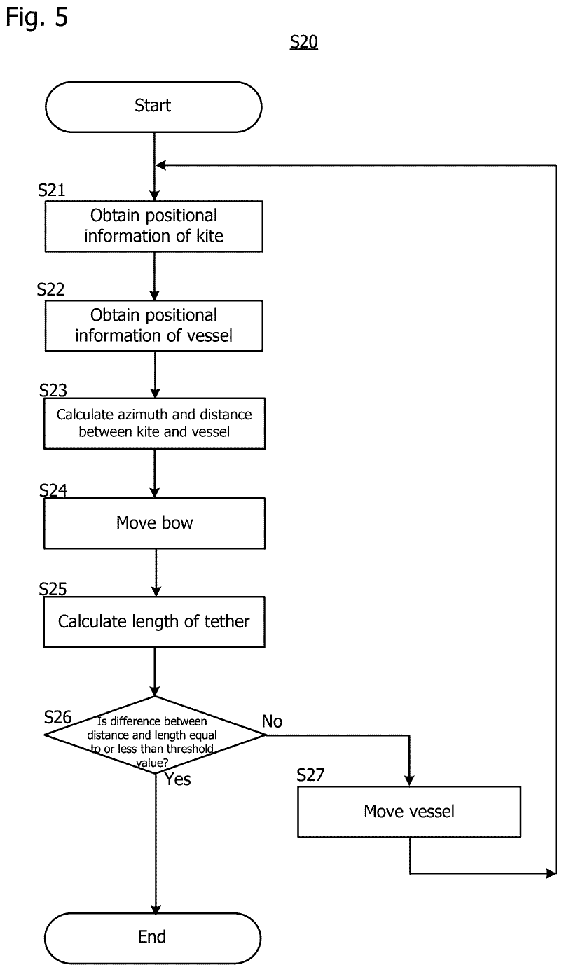

### DESCRIPTION OF THE PREFERRED EMBODIMENTS

In the following, as one form example of a flying object, an example applied to a kite to be floated in air by the principle of a kite will be described. The present disclosure is applicable to this other form of flight, and is applicable to, for example, a closed balloon, a deployment wing, or the like.

### 1. Example 1

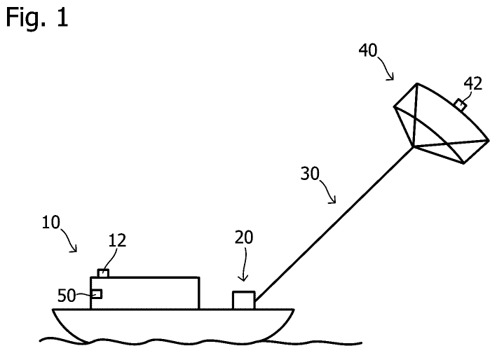

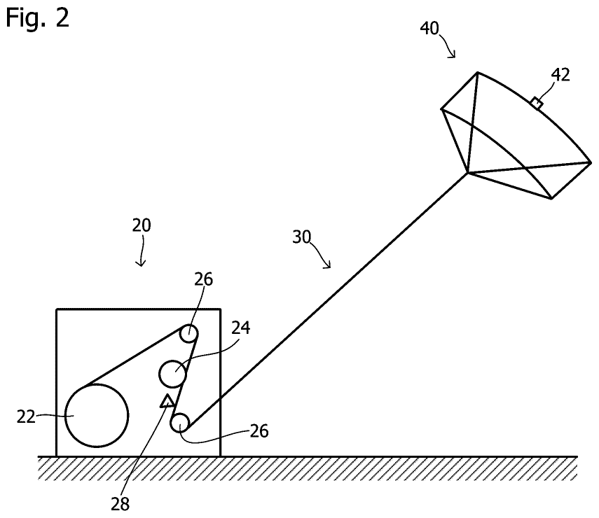

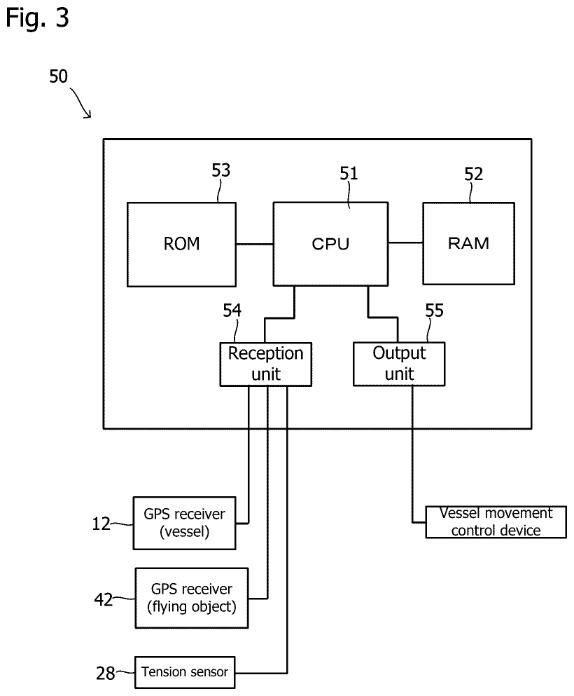

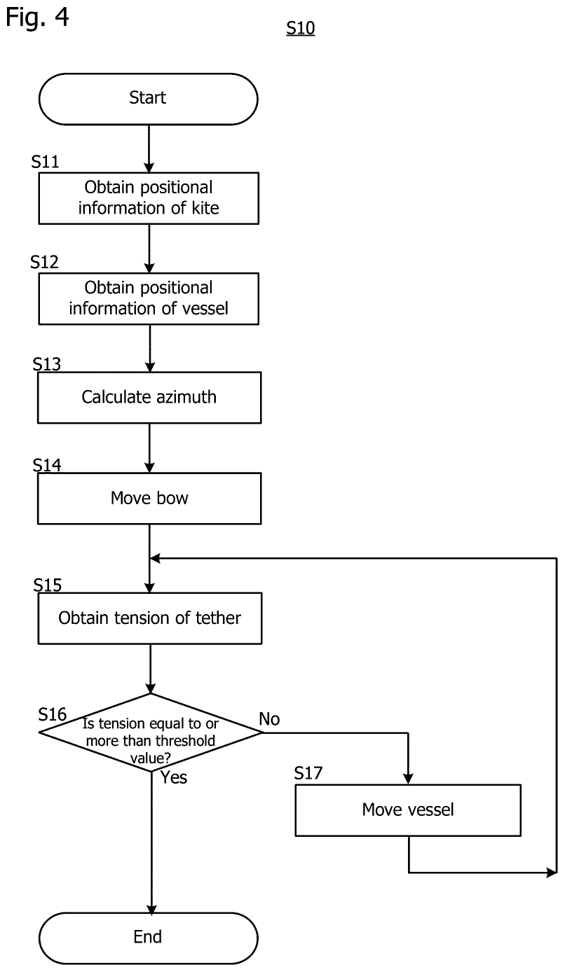

FIGS. 1 to 4 illustrate a S10 of how to control the tension of the tether according to Form 1. FIG. 1 is a diagram for explaining various devices provided, FIG. 2 is a diagram in which attention is paid to a part of FIG. 1 (a winch 20, a tether 30, and a kite 40), FIG. 3 is a diagram for explaining a controller 50, and FIG. 4 is a diagram showing a flow S10 the tension control methods of the tether.

To provide S10 of the tensioning methods of the tethers, a vessel 10, winch 20, tether 30, kite 40, and controller 50 are provided, e.g., as shown in FIG. 1.

### 1.1. Ships

Vessel 10 is a measures for mooring kite 40 over a desired sea or water and is configured to be capable of moving over the sea or water. A more specific embodiment of the vessel 10 is not particularly limited as long as it can move on water.

The vessel 10 is typically equipped with a GPS receiver 12, a winch 20, and a controller 50 in addition to various known equipment for operating the vessel.

GPS receiver 12 is a Global Positioning System receiver, and is able to know the longitude and latitude of GPS receiver 12. GPS receiver 12 is provided in the vessel 10, thereby obtaining the position of the vessel.

### 1.2. Winch

The winch 20, as also shown in FIG. 2, is an instrument connected to the kite 40 for pulling out and winding the tether 30 to anchor the kite 40 in the air. To that end, the winch 20 of this form includes a spool 22 for winding and storing the tether 30, and a friction drive roller 24 disposed between the spool 22 and the kite 40 for winding and rotationally driving the tether 30. Also wrapped around pulley 26 between spool 22 and friction drive roller 24 and between friction drive roller 24 and kite 40. In the winch 20, one end of the tether 30 wound around the circumferential surface of the spool 22 is pulled out from the spool 22, is wound several times around the circumferential surface of the friction drive roller 24 through the pulley 26, and is then connected to the kite 40 through another pulley 26.

A tension sensor 28 for measuring the tension of the tether 30 is disposed between the friction drive roller 24 and the kite 40. Thus, it is possible to obtain the tension of the tether 30 for anchoring the kite 40. The tension sensor 28 may be a known one, and the embodiment thereof is not particularly limited, but is preferably configured so as to be capable of outputting a measurement result as a signal.

### 1.3. Tether

The tether 30 is as is known and is a string-like member for anchoring the kite 40

### 1.4. Kite

The kite 40 is an aspect of a flying object, and is an instrument floating in the air by the principle of a so-called kite.

As described above, an example in which a kite is applied as a flying object has been described in this form, but a balloon, a deployment wing, or the like can be applied instead of a kite. The kite 40 has one end of the tether 30 (end opposite to the end of the winch 20 side) is connected to be moored.

The kite 40, GPS receiver 42 is disposed. GPS receiver 42 is a Global Positioning System receiver, and is able to know the longitude and latitude of GPS receiver 42. GPS receiver 42 can obtain the position of the kite thereby provided in the kite 40.

### 1.5. Controller

Controller 50 is a controller for executing the respective processes of the tension control methods S10 of the tether of the present embodiment. In this form, it is arranged in the ship 10, but is not particularly limited, and may be provided in the winch 20 or the kite 40

In the present embodiment, the controller 50 is at least, position information from GPS receiver 12 provided in the ship 10, the position information from GPS receiver 42 provided in the kite 40, and the tension information from the tension sensor 28 acquired, a controller for controlling the transfer of the ship. However, it is not necessary to be a controller only for that purpose, and other functions for controlling the vessel 10 may be provided. Although there is no particular limitation on the embodiment of the controller 50, it may typically be configured by a computer. FIG. 3 conceptually shows an example of the configuration of the computer 50 as a controller 50.

The computer 50 includes a CPU (Central Processing Unit that is a processor, 51, a RAM (Random Access Memory that acts as a workspace, 52, a ROM (Read-Only Memory as a storage medium, 53, a receiver 54 that is an interface that accepts information to the computer 50 regardless of whether it is wired or wireless, and an output 55 that is an interface that transmits information, whether wired or wireless, from the computer 50 to the outside. The receiving section 54 is provided with a GPS receiver 12, a GPS receiver 42, and a tension sensor 28 which are connectable to transfer signals and can acquire position information and tension information by signals, and the outputting section 55 is provided with a movement control device of a ship which is connectable to transfer signals and can control the movement of the ship 10.

In the computer 50, each process for the control carried out S10 the tension control methods of the tether of this form is made into a specific instruction, and the computer program for performing this is stored. In computer 50, CPU51, RAM52 as a hardware resource, and ROM53 and computer programs work together. Specifically, CPU51 implements a function by executing a computer program recorded in a ROM53 on the basis of the position information acquired through the reception unit 54 and the tension information of the tether 30 in a RAM52 that functions as a work area. The data acquired or generated by CPU51 is stored in RAM52. Then, a transfer instruction is transmitted to the ship via the output unit 55 if necessary based on the obtained result.

Specific contents of the control will be described below.

### 1.6. Tension Control Method for Tethers

In S10 of the tension control of the tether of this form, the movements of the ship are controlled according to the obtained position informations and the tension of the tether. Such control is performed by the control by the controller 50 in the present embodiment. Each process will be described based on the flow shown in FIG. Each of these processes is performed by the controller 50 based on a program stored in the controller 50 as described above, collecting and calculating information from each device, and controlling each device by the result.

### [Obtain Location Information]

In the process S11 of kite position information acquisition, the latitude and longitude of kite 40 is acquired from GPS receiver 42.

### [Acquisition of Vessel Position Information].

In the process S12 of obtaining the ship's position data, the latitude and longitude of the ship 10 are obtained from GPS receiver 12.

### [Calculation of Azimuth]

In the process S13 for calculating the azimuth angle, the azimuth angle connecting them is calculated from the positional information of the kite 40 obtained by the process S11 for obtaining the kite positional information and the positional information of the ship 10 obtained by the process S12 for obtaining the ship's positional information.

### [Moving the Bow]

In the process S14 of the movement of the bow, the ship is moved so that the bow of Vessel 10 matches the azimuth calculated in the process S13 of the calculation of the azimuth angle.

### [Acquisition of Tether Tension].

In the process S15 of obtaining the tether tension, the tension of the tether 30 is obtained from the tension sensor 28

### [Judgment]

In the process S16 of the determination, it is determined whether or not the tension of the tether 30 acquired in the process S15 of obtaining the tether tension is equal to or larger than a threshold. The threshold value is not particularly limited as long as it is a value at which the kite 40 can continue stable flight, but may be, for example, a tension at which the possibility that the tether 30 is detached from the pulley 26 increases.

Here, if the tension is greater than or equal to the threshold, the kite 40 is Yes because it is considered to be capable of stable flight, and ends the tension control S10 of the tether. However, this tension control S10 of the tether is performed again after a lapse of a predetermined period of time to maintain a stable flight of the kite 40

On the other hand, if the tension is lower than the threshold value, there is a possibility that a stable flight of the kite 40 becomes difficult. So it is No to move to “the process S17 of moving the vessel.”

### [Ship Movement]

In the process S17 of the transfer of the ship, the transfer of the ship is carried out. Since the bow of a vessel is oriented S14 the course of its bow movement, it is only necessary to proceed as it is in this process S17. According to this, it is possible to increase the tension of the tether 30 which has been lowered by the movement of the ship 10. Thereafter, it is repeated from the process S15 of obtaining the tether tension described above.

### 1.7. Effect, etc.

As the distance between the vessel and the kite approaches, the tether becomes loose and the tether tension decreases. As a result, there is a possibility that the tether may be entangled by detachment of the tether from the pulley or the like of the winch. If the tether is rolled up to restore tension, the kite can fall as previously described. Therefore, in this form, the azimuth angle is calculated from the values of the kite and GPS receiver mounted on the ship, and the ship is controlled so that the bow of the ship is directed toward the azimuth angle. Then, when the value of the tension sensor of the tether falls below a value which may deviate from the pulley, the ship is moved toward the bow to restore the tension of the tether. With this method, it is possible to prevent a decrease in the altitude of the kite by winding the tether more than necessary, so that it is possible to maintain a stable flight, such as preventing the chite from falling down.

### 2. Form Example 2

In Form Example 2, a tether length measuring device is placed instead of the tension sensor 28 among the above-described Form Example 1 Since other configurations can be considered in the same manner as in Form 1 described above, description thereof will be omitted here.

### 2.1. Tether Length Measuring Device

The tether length measuring device detects the length of the tether 30 that is being withdrawn from the spool 22 at that time. Specific embodiments of the device are not particularly limited, and examples thereof include the following apparatus.
Measure the distance between the sensor and the outermost peripheral surface of the tether wound on the spool with a laser displacement meter, etc., The tether is pre-marked on the tether and imaged by the camera, and the tether length is calculated by measuring the tether delivery speed.
The relationship between the number of turns of the spool and the tether length is obtained in advance, and the tether length is calculated by obtaining the number of turns of the spool.

### 2.2. Tension Control of the Tether

In the tension control S20 of the tether of this form, the movements of the ship are controlled according to the obtained positional informations and the drawing length of the tether. Such control is performed under the control of the controller 50 in the present embodiment (however, the tether length measuring device is connected instead of the tension sensor.) Each process will be described based on the flow shown in FIG. Each of these processes is performed by the controller 50 based on a program stored in the controller 50 as described above, collecting and calculating information from each device, and controlling each device by the result.

### [Obtain Location Information]

In the process S21 of kite position information acquisition, the latitude and longitude of kite 40 is acquired from GPS receiver 42.

### [Acquisition of Vessel Position Information].

In the process S22 of obtaining the ship's position data, the latitude and longitude of the ship 10 are obtained from GPS receiver 12.

### [Calculation of Azimuth Angle and Distance Between Kite and Ship]

In the process S23 of calculating the azimuth angle and the distance between the kite and the ship, the azimuth angle and the distance connecting them are calculated from the positional information of the kite 40 obtained by the process S21 of the kite positional information acquisition and the positional information of the ship 10 obtained by the process S22 of the ship's positional information acquisition.

### [Moving the Bow]

In the process S24 of the movement of the bow, the vessel is moved so that the bow of the vessel 10 matches the azimuth angle obtained in the process S23 of the calculation of the azimuth angle and the distance between the kite and the vessel.

### [Acquisition of Tether Length].

In the process S25 of obtaining the tether length, the length from which the tether 30 is pulled out from the above-described tether length measuring device is obtained.

### [Judgment]

In S26 of the judgment process, the difference between “the distance between the boat and the kite” and “the lead-out length of the tether” obtained so far is determined as to whether the “lead-out length of the tether”−“the distance between the kite and the boat” is below the thresholds. In the case of “Distance between the kite and the ship”< “Lead-out length of the tether” the tether tension is decreasing, and if “Lead-out length of the tether”−“Distance between the kite and the ship” increases to a certain extent (threshold), the kite 40 may become unable to continue stable flight. Therefore, it is determined whether the present state is equal to or less than the threshold value. Although the specific threshold value is not particularly limited as long as it is a value capable of maintaining the flight stability of the kite, for example, a value which increases the possibility that the tether 30 is detached from the pulley 26 can be mentioned.

Here, if the differences are below the thresholds, the kite 40 is Yes because it is considered to be capable of stable flight, and ends the tension control S20 of the tether. However, this tension control S20 of the tether is performed again after a lapse of a predetermined period of time to maintain a stable flight of the kite 40

On the other hand, if the difference is higher than the threshold value, stable flight of the kite 40 may be difficult. So it is No to move to “the process S27 of moving the vessel.”

### [Ship Movement]

In the process S27 of ship movement, ship movement is carried out. Since the bow of a vessel is oriented S24 the course of its bow movement, it is only necessary to proceed as it is in this process S27. According to this, it is possible to increase the tension of the tether 30 which has been lowered by the movement of the ship 10. Thereafter, it is repeated from the process S21 of the kite position information acquisition described above.

### 2.3. Effect, etc.

In this form, the effect described in Embodiment 1 has the same effect.

### 3. Other

The flight vehicle to which the tension control method of the tether of the present disclosure is applied can be applied as a high-altitude platform for, for example, wind power generation, photovoltaic power generation, communication relaying, weather observation, and experimental bases in the air.

Further, the position information of the kite may include an altitude in addition to longitude and latitude. The altitude can be obtained by a known altitude meter.

### REFERENCE SIGNS LIST

10 . . . . Vessel, 12 . . . . GPS receiver, 20 . . . winch, 30 . . . tether, 40 . . . kite (flight vehicle), 50 . . . controller

What is claimed is:

1. A method of controlling tension of a tether, a flying object being moored using the tether to a vessel, the method comprising:
moving the vessel in such a direction that the tension recovers when the tension that is detected by a sensor detecting the tension is less than a threshold value.

2. A method of controlling tension of a tether, a flying object being moored using the tether to a vessel, the method comprising:
moving the vessel in such a direction that the tension recovers when difference obtained by subtracting a distance between the vessel and the flying object from a drawing length of the tether that is detected using a sensor detecting the drawing length exceeds a threshold value.

3. The method of controlling tension according to claim 1, wherein
the direction is determined by an azimuth between the vessel and the flying object based on positional information of the flying object and positional information of the vessel.

4. The method of controlling tension according to claim 3, wherein
the positional information of the flying object and the positional information of the vessel are obtained by GPS.
